(19) United States
(12) Patent Application Publication
(10) Pub. No.: US 2004/0068534 A1
(43) Pub. Date: Apr. 8, 2004

(54) System for transmitting signalings between different networks

(76) Inventors: Manfred Angermayr, Schrobenhausen (DE); Klaus David Gradischnig, Reston, VA (US); Helmut Richter, Freising (DE); Volker Stucky, Munchen (DE)

Correspondence Address: MORRISON & FOERSTER LLP, 1650 TYSONS BOULEVARD, SUITE 300, MCLEAN, VA, 22102, US

(21) Appl. No.: 10/433,952

(22) PCT Filed: Dec. 21, 2001
(86) PCT No.: PCT/DE01/04891

(30) Foreign Application Priority Data
Jan. 2, 2001 (DE) 101 00 071.5
Apr. 11, 2001 (DE) 101 18 193.0

(51) Int. Cl. G06F 15/167

(52) U.S. Cl. 709/200

(57) ABSTRACT

The invention relates to a method for transmitting signalings in different networks which is characterized in that at least two signaling gateways are interlinked using a point-to-point protocol for symmetric and quasi-associated signaling.

The invention relates to a system for transmitting signaling between different networks.

It is known that a signaling gateway allows the transfer of CCS7 (Common Channel Signaling System 7) signaling from a CCS7 network with CCS7 connections to another network, in particular an IP network. An M3UA (MTP Level 3 User Adaptation) protocol is provided for this transfer.

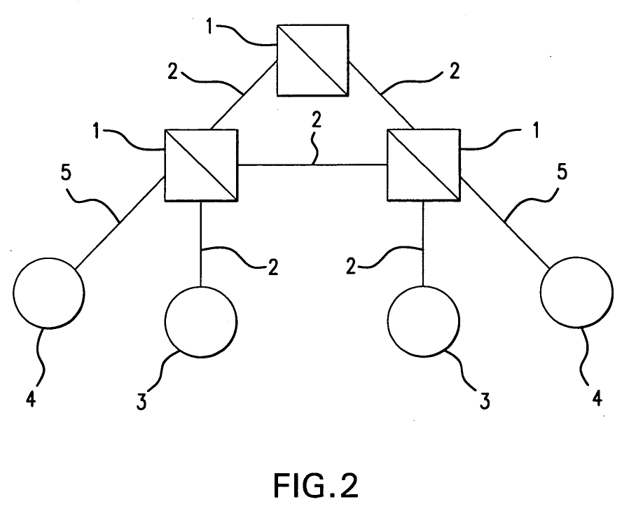

An exemplary embodiment of a network connection used to date is shown in FIG. 3. In this configuration the signaling gateways 1 are interlinked by means of CCS7 connections 5—unlike the configuration in FIG. 2. These connections are based on CCS7-specific hardware and a CCS7-specific software solution in respect of a security protocol. A CCS7 signaling message from an MTP signaling end point 4 to a further MTP signaling end point 4 or to an M3UA signaling end point 3 via one of the signaling gateways 1 is only possible via a CCS7 connection 5.

Network systems currently available have up to now used CCS7 links for a CCS7 connection between two signaling gateways. One disadvantage of such signaling is that an internet connection using an M3UA protocol is not possible, as this only covers a point-to-point connection—typically from the signaling gateway to the media controller. As the signaling gateways in this configuration however only operate as signaling transfer points, a connection via an internet protocol (IP) using the M3UA protocol is not possible.

It is known that CCS7 links can be provided to allow a connection between at least two signaling gateways. It is also known that an M2UA connection can be used. Their specification is however not yet sufficiently advanced to allow use in the foreseeable future. (There is no restriction with regard to scope).

The object of the invention is to specify a system which allows connection of at least two signaling gateways using standard protocols.

This object is achieved by means of a method according to claim 1. According to this the object is achieved by means of a system or method, in which at least two signaling gateways are interlinked using a point-to-point protocol for symmetric and quasi-associated signaling.

One important aspect of the invention is that M3UA routing information is integrated into a routing database of a CCS7 message transfer part. The principle of the MTP routing database is that all direct links (point-to-point connections) to an adjacent node are combined in a linkset. These linksets are always referred to in a route description to a destination. A destination must not however be located directly behind a linkset referred to but may also refer to a linkset to a signaling transfer point for quasi-associated signalings. Therefore information about the entire route is not required, simply information about the outgoing linkset.

According to this principle an M3UA connection is now integrated via IP. An M3UA connection to an adjacent node is then simply seen as a linkset. Then not only a CCS7 linkset but also an IP linkset is used to specify an outgoing route in a route description to a destination. A linkset is then—generally defined—to be seen as a direct connection between two adjacent nodes.

For the route description—i.e. for the description of the node(s) via which the required destination is reached—it is completely irrelevant to the inventor whether a linkset with CCS7 links is used as the transport medium or an M3UA connection via the internet protocol (IP). It is therefore possible to set up an IP linkset between at least two signaling gateways and by means of the general route description to use these signaling gateways as signaling transfer points.

Since the M3UA protocol involves a client-server architecture, it is necessary to specify for the two (in fact equal) connected signaling gateways which signaling gateway acts as a client and which as a server. This can be done, for instance, by means of an attribute of the IP linkset. The IP linkset is in this case regarded as active as soon as the M3UA connection is established.

Generally a signaling gateway receives M3UA messages via an M3UA connection which is intended for a remote destination point in the CCS7 network. If the messages are not intended for the signaling gateway, they are transferred to a routing function, and then forwarded in accordance with their destination point. The messages are in this case converted from the M3UA message format to a CCS7 MTP message format. This function is executed regardless of whether the signaling gateway for the IP linkset involved is configured as an M3UA client or an M3UA server.

In a further embodiment of the invention a signaling gateway receives a CCS7 MTP message from the CCS7 network and forwards this to an M3UA destination point, which operates as a CCS7 signaling end point. The message is then converted from CCS7 MTP message format to the M3UA message format. The transparent integration of the M3UA connection into the MTP means that even those messages which are intended for destinations other than the other end point of the M3UA connection can now be forwarded to the IP network. This function is executed regardless of whether the signaling gateway for the IP linkset involved is configured as a client or as a server.

The present invention means that CCS7 messages from the CCS7 network can be routed back again via an IP network into a CCS7 network, with a signaling gateway executing the necessary conversion of the messages at the interface between an IP and a CCS7 network.

So that all the CCS7 network requirements—in particular those of MTP network management—can now be satisfied, the M3UA protocol of such an M3UA transfer signaling gateway must now demonstrate a specific response. It must demonstrate an M3UA client response even if it is actually on the M3UA server side. Also specific message formats must be processed specially. Special processing of the message formats can be achieved by means of an assessment of each message using the relevant integrated MTP/M3UA routing database.

Advantages and suitabilities of the invention are incidentally revealed in the subclaims and the subsequent description of preferred exemplary embodiments, which are described in more detail using the drawings. These show:

FIG. 3 a network connection as used to date with signaling gateways, which are interlinked by means of CCS7 connections;

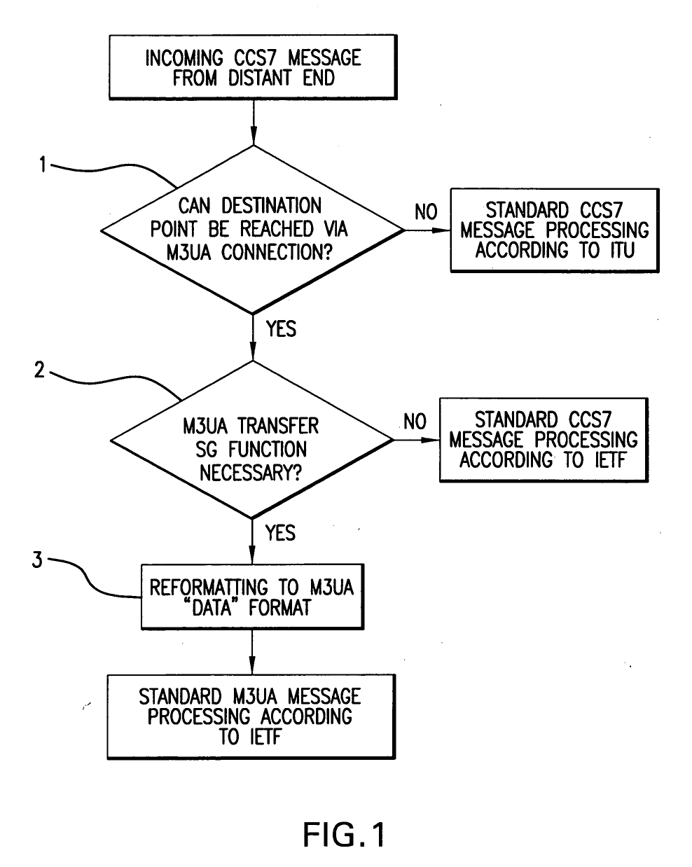

FIG. 1 a flow diagram of message signaling of an M3UA protocol in a signaling gateway; and

FIG. 2 a network connection with signaling gateways, which are interlinked by means of M3UA connections.

The same reference numbers are used for the same parts and parts with the same action in the description below.

FIG. 1 shows a flow diagram adapted according to the invention of the message signaling of an M3UA protocol in a signaling gateway 1. The qualification 1 corresponds to an existing functionality of a signaling gateway 1.

The response to the qualification 2 is “yes” when a CCS7 message is received, the destination point of which is reached via an outgoing M3UA connection 2 which does not lead directly to an end point connection. (In a further embodiment of the invention these routes are already equipped with an M3UA transfer signaling gateway identifier). The response to the qualification 2 is “no”, when the destination is directly behind the M3UA connection.

If the response relating to the CCS7 messages in the qualification 2 is “yes”, they are not converted to the corresponding specific M3UA format but to the M3UA “data” format and are transferred via an M3UA connection 2 to a signaling gateway 1. This stage is necessary, as neither the source nor the destination of the message is included in the M3UA format, with the exception of the “data” format, and such messages can therefore only be transmitted via a route which leads directly to the destination point of the corresponding M3UA message.

If the response to the qualification 2 is “no”, specific CCS7 messages are converted to the M3UA format. CCS7 messages, which come from a different node and are sent to a directly adjacent signaling gateway 1, are transported in an M3UA “data” format, so that the reference to the message source is not lost. The M3UA of a signaling gateway 1 forwards a received message using the analyzed information to an MTP-L3 network management. In the event that the destination point is an MGC (Media Gateway Controller), all CCS7 network management messages apart from TFC (Transfer Controlled) messages and UPU (User Part Unavailable) messages are rejected. In a further embodiment of the invention these messages are also transported in “data” format if the MGC supports this format for MTP network management messages. If a signaling gateway 1 itself generates network management messages to a further signaling gateway 1, they are transmitted in the M3UA format. Only CCS7 messages declared as data messages are therefore sent.

FIG. 2 shows an exemplary embodiment of a network connection according to the invention. The signaling gateways 1 are interlinked by means of M3UA connections 2. In this embodiment the signaling gateways 1 are interlinked by means of a mesh connection. In a further embodiment network connections by means of a star connection or a ring connection are also possible. The M3UA connection 2 preferably uses an internet protocol (IP) to address the message packets via the internet.

If a CCS7 signaling message is sent from an MTP signaling end point 4 to a further MTP signaling end point 4 or to an M3UA signaling end point 3, said message can be transported in the network between the signaling gateways 1 without using specific CCS7 connections 5. Second-choice CCS7 routes can also be set up as M3UA connections 2. The choice of second-choice route is made in accordance with CCS7P-MTP-specific protocols.

1. System for transmitting signaling between different networks, characterized in that at least two signaling gateways (1) are interlinked using a point-to-point protocol for symmetric and quasi-associated signaling.

2. System according to claim 1,
characterized in that an IP network is used as the network connection.

3. System according to claim 1 or 2,
characterized in that a standard protocol, in particular an M3UA protocol, is used as the point-to-point protocol.

4. System according to claim 1,
characterized in that M3UA routing information is integrated into a routing database of a CCS7 message transfer part.

5. System according to claim 1,
characterized in that an IP linkset is set up between the signaling gateways (1) and the signaling gateways are used as signaling transfer points (STP) by means of a general route description.

6. System according to one of the preceding claims, characterized in that a client-server attribute of the connected signaling gateways (1) is established via an attribute of the IP linkset.

7. System according to one of claims 5 or 6,
characterized in that messages which are intended for destinations other than a different end point of the M3UA connection (2) are forwarded via an IP linkset into an IP network.

8. System according to claim 7, characterized in that a route description to a destination uses an M3UA connection (2).

9. System according to one of the preceding claims,
characterized in that CCS7 network management is supported for network transfers.

10. System according to one of the preceding claims, in particular according to claim 9,
characterized in that at least two signaling gateways (1) are used as CCS7 signaling gateways, which are interlinked via an IP network.

11. System according to one of the preceding claims,
characterized in that CCS7 messages from a CCS7 network with CCS7 connections (5) are routed back again via an IP network into a further CCS7 network with CCS7 connections (5), with the signaling gateway (1) executing the necessary conversion of the messages.

12. System according to one of the preceding claims, characterized in that a received CCS7 message, the destination point of which is reached via an outgoing M3UA connection (2), which does not lead directly to a connection destination, is converted to an M3UA format.

13. System according to one of the preceding claims, characterized in that a received CCS7 message, the destination point of which is not reached via an outgoing M3UA connection (2), which does not lead directly to a connection end point, is converted to an M3UA “data” format and transferred via M3UA to a signaling gateway.

14. Signaling gateway for implementing the system according to one of the preceding claims, characterized by a conversion system that executes the conversion of messages at an interface between an IP network and a CCS7 network.
